(19) United States
(12) Patent Application Publication
(10) Pub. No.: US 2013/0232373 A1
(43) Pub. Date: Sep. 5, 2013

(54) METHOD FOR PERFORMING REAL TIME CLOCK CALIBRATION THROUGH FRAME NUMBER CALCULATION, AND ASSOCIATED APPARATUS

(71) Applicants: Tung-Yi Wang, New Taipei City (TW); Chih-Chong Wang, Hsinchu City (TW); Chun-Ming Kuo, Hsinchu City (TW)

(72) Inventors: Tung-Yi Wang, New Taipei City (TW); Chih-Chong Wang, Hsinchu City (TW); Chun-Ming Kuo, Hsinchu City (TW)

(21) Appl. No.: 13/409,116

(22) Filed: Mar. 1, 2012

(51) Int. Cl. G06F 11/00

(52) U.S. Cl. 713/503

(57) ABSTRACT

A method and apparatus for performing real time clock (RTC) calibration through frame number calculation are provided, where the method is applied to an electronic device. The method includes the steps of: before power failure of the electronic device occurs, obtaining an original time value from an RTC of the electronic device and storing the original time value and a frame number of a first frame into a storage unit; and after the electronic device is powered on since elimination of the power failure, obtaining a frame number of a second frame and performing at least one calculation operation according to the frame number of the second frame, the frame number of the first frame, and the original time value to determine a calibrated time value of the RTC, and updating the RTC with at least one of the calibrated time value and a derivative of the calibrated time value.

### BACKGROUND

The present invention relates to time calibration of an electronic device, and more particularly, to a method for performing real time clock (RTC) calibration through frame number calculation, and to an associated apparatus.

According to the related art, a portable electronic device equipped with a touch screen (e.g., a multifunctional mobile phone, a personal digital assistant (PDA), a tablet, etc) can be very helpful to an end user. In a situation where malfunction of both of a battery (e.g. a Lithium (Li)-ion/Li-polymer battery) of the portable electronic device and a supplementary power source of a real time clock (RTC) within the portable electronic device (e.g. a button-shaped or coin-shaped battery) occurs, some problems may occur. More particularly, the end user may need to replace or charge the battery of the portable electronic device (e.g. the Li-ion/Li-polymer battery) in some occasions, and malfunction of the supplementary power source of the RTC may cause an oscillator of the RTC to stop oscillating during replacement or power deficiency of the battery. Thus, a novel method is required for time recovery of an electronic device.

### SUMMARY

It is therefore an objective of the claimed invention to provide a method for performing real time clock (RTC) calibration through frame number calculation, and to provide an associated apparatus, in order to solve the above-mentioned problems.

An exemplary embodiment of a method for performing RTC calibration through frame number calculation is provided, where the method is applied to an electronic device. The method comprises the steps of: before power failure of the electronic device occurs, obtaining an original time value from an RTC of the electronic device and storing the original time value and a frame number of a first frame into a storage unit, wherein the first frame is received from a base station; and after the electronic device is powered on since elimination of the power failure, obtaining a frame number of a second frame and performing at least one calculation operation according to the frame number of the second frame, the frame number of the first frame, and the original time value to determine a calibrated time value of the RTC, and updating the RTC with at least one of the calibrated time value and a derivative of the calibrated time value.

An exemplary embodiment of an apparatus for performing RTC calibration through frame number calculation is provided, where the apparatus comprises at least one portion of an electronic device. The apparatus comprises a storage unit and a processing circuit. The storage unit is arranged to temporarily store information. In addition, the processing circuit is arranged to control operations of the electronic device. Before power failure of the electronic device occurs, the processing circuit obtains an original time value from an RTC of the electronic device and stores the original time value and a frame number of a first frame into the storage unit, wherein the first frame is received from a base station. In addition, after the electronic device is powered on since elimination of the power failure, the processing circuit obtains a frame number of a second frame and performs at least one calculation operation according to the frame number of the second frame, the frame number of the first frame, and the original time value to determine a calibrated time value of the RTC, and updates the RTC with at least one of the calibrated time value and a derivative of the calibrated time value.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of an apparatus for performing real time clock (RTC) calibration through frame number calculation according to a first embodiment of the present invention.

FIG. 2 illustrates a flowchart of a method for performing RTC calibration through frame number calculation according to an embodiment of the present invention.

FIG. 3 illustrates a time recovery scheme involved with the method shown in FIG. 2 according to an embodiment of the present invention.

FIG. 4 illustrates another time recovery scheme involved with the method shown in FIG. 2 according to some embodiments of the present invention.

FIG. 5 illustrates another time recovery scheme involved with the method shown in FIG. 2 according to some embodiments of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

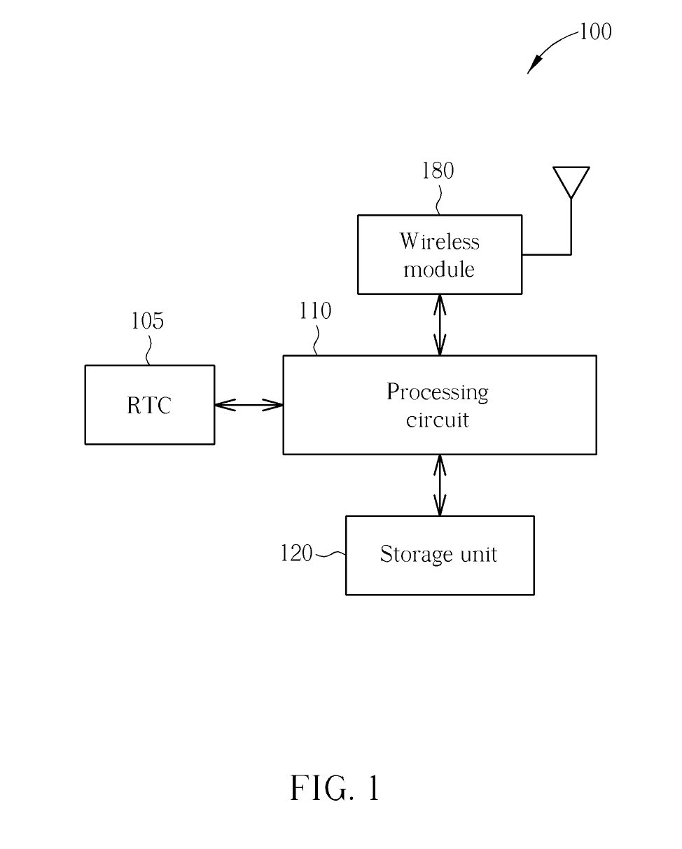

Please refer to FIG. 1, which illustrates a diagram of an apparatus 100 for performing real time clock (RTC) calibration through frame number calculation according to a first embodiment of the present invention. According to different embodiments, such as the first embodiment and some variations thereof, the apparatus 100 may comprise at least one portion (e.g. a portion or all) of an electronic device such as a portable electronic device. For example, the apparatus 100 may comprise a portion of the electronic device mentioned above, and more particularly, can be a control circuit such as an integrated circuit (IC) within the electronic device. In another example, the apparatus 100 can be the whole of the electronic device mentioned above. In another example, the apparatus 100 can be an audio/video system comprising the electronic device mentioned above. Examples of the electronic device may include, but not limited to, a mobile phone (e.g. a multifunctional mobile phone), a personal digital assistant (PDA), a portable electronic device such as the so-called tablet (based on a generalized definition), and a personal computer such as a tablet personal computer (which can also be referred to as the tablet, for simplicity), a laptop computer, or desktop computer.

As shown in FIG. 1, the apparatus 100 comprises an RTC 105, a processing circuit 110, a storage unit 120, and a wireless module 180, which is equipped with at least one antenna such as that shown in FIG. 1. The RTC 105 is arranged to keep track of the current time for the electronic device. In addition, the processing circuit 110 is arranged to control operations of the electronic device, and under control of the processing circuit 110, the wireless module 180 is arranged to perform wireless communication regarding a wireless communication function of the electronic device (e.g. a mobile phone function of the electronic device). Additionally, the storage unit 120 is arranged to temporarily store information. For example, the storage unit 120 can be a non-volatile memory such as a Flash memory, or can be a hard disk drive (HDD).

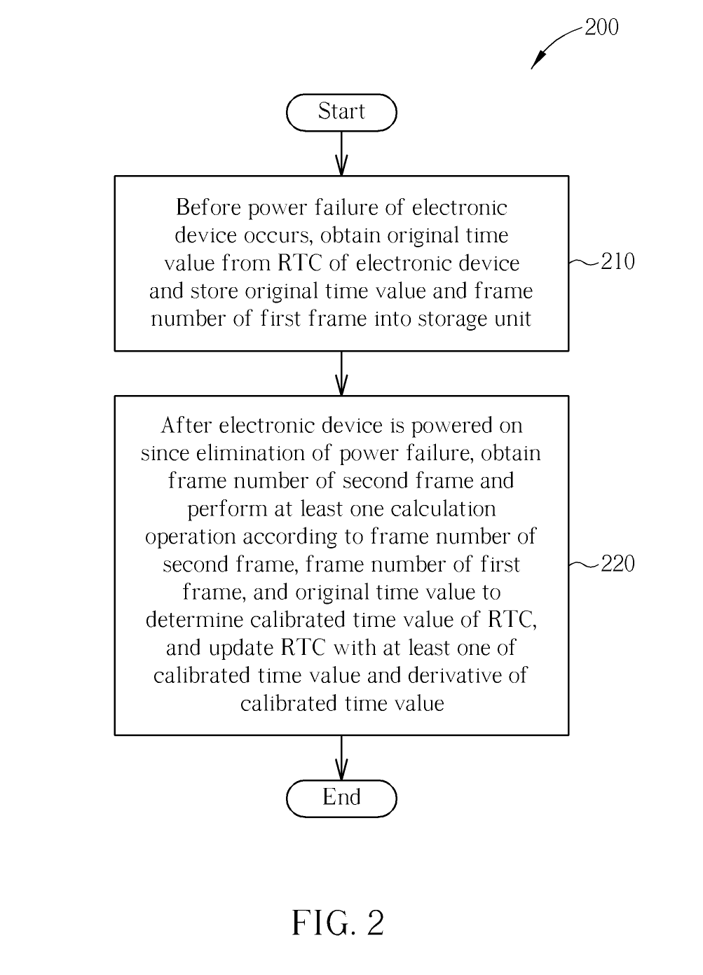

According to this embodiment, the processing circuit 110 is further arranged to perform RTC calibration (e.g. recover the time accuracy of the RTC 105) according to at least a portion of the information stored in the storage unit 120. For example, in a situation where the RTC 105 of the electronic device is not accurate enough, the RTC calibration performed by the processing circuit 110 can recover the time accuracy. In another example, in a situation where the RTC 105 of the electronic device stops working during power failure of the electronic device (e.g. the RTC 105 does not have any valid power source such as a workable capacitor or a workable button-shaped or coin-shaped battery during replacement of a Lithium (Li)-ion/Li-polymer battery of the electronic device, or an oscillator of the RTC 105 stops oscillating due to replacement or deficiency of a supplementary power source of the RTC 105, such as a capacitor or a button-shaped or coin-shaped battery), the RTC calibration performed by the processing circuit 110 can recover the time accuracy. Please note that, as a result of applying the RTC calibration performed by the processing circuit 110, it is workable to reduce related costs by omitting designing a supplementary power source (e.g. a capacitor or a button-shaped or coin-shaped battery) for the RTC 105 since the RTC calibration performed by the processing circuit 110 can recover the time accuracy. Referring to FIG. 2, some implementation details of the RTC calibration are further described in the following embodiments.

FIG. 2 illustrates a flowchart of a method 200 for performing RTC calibration through frame number calculation according to an embodiment of the present invention. The method shown in FIG. 2 can be applied to the apparatus 100 shown in FIG. 1. The method is described as follows.

In Step 210, before power failure of the electronic device occurs, the processing circuit 110 obtains an original time value RTC0 from the RTC 105 of the electronic device and stores the original time value RTC0 and a frame number of a first frame into the storage unit 120, where the first frame is received from a base station. More particularly, the processing circuit 110 obtains the original time value RTC0 from the RTC 105 after the first frame is received from the base station. For purpose of maintaining the highest accuracy available, the processing circuit 110 typically obtains the original time value RTC0 from the RTC 105 before the frame next to the first frame is received from the base station. Thus, the resolution of the RTC calibration can be equivalent to the duration per frame, such as 4.615 milliseconds (ms) in some communication standards.

In Step 220, after the electronic device is powered on since elimination of the power failure, the processing circuit 110 obtains a frame number of a second frame and performs at least one calculation operation according to the frame number of the second frame, the frame number of the first frame, and the original time value RTC0 to determine a calibrated time value of the RTC 105, and updates the RTC 105 with at least one of the calibrated time value RTC_FN and a derivative of the calibrated time value RTC_FN (e.g. the calibrated time value RTC_FN and/or the aforementioned derivative of the calibrated time value RTC_FN). For simplicity, in some variations of this embodiment, the processing circuit 110 can update the RTC 105 with the calibrated time value RTC_FN, without generating the aforementioned derivative of the calibrated time value RTC_FN by modifying the calibrated time value RTC_FN.

According to an embodiment, such as a variation of the embodiment shown in FIG. 2, the aforementioned power failure may represent the power failure of the battery of the electronic device (e.g. the Li-ion/Li-polymer battery of the electronic device). When it is detected that replacing or charging the battery is required, the processing circuit 110 triggers Step 210, the step of obtaining the original time value RTC0 from the RTC 105 of the electronic device and storing the original time value RTC0 and the frame number of the first frame into the storage unit 120. More particularly, the processing circuit 110 can detect whether an output voltage level of the battery is less than a predetermined threshold to determine whether replacing or charging the battery is required. For example, when the output voltage level of the battery is less than the predetermined threshold, the processing circuit 110 determines replacing or charging the battery is required.

According to some embodiments, such as some variations of the embodiment shown in FIG. 2, the processing circuit 110 can provide the user with a user interface, allowing the user to select a derivative of the frame number of the second frame, for use of performing the aforementioned at least one calculation operation. For example, the derivative of the frame number of the second frame can be equivalent to the frame number of the second frame plus the number of frames of a super-frame. In another example, the derivative of the frame number of the second frame can be equivalent to the frame number of the second frame plus a multiple of the number of frames of the super-frame.

According to some embodiments, such as some variations of the embodiment shown in FIG. 2, the processing circuit 110 can utilize the communication module 180 to access a synchronization channel (SCH) such as a downlink only control channel used in some cellular telephone systems (e.g. Global System for Mobile Communications (GSM) systems). For example, the purpose of the SCH may comprise allowing the mobile station (or the handset), which can be taken as an example of the electronic device mentioned above, to quickly identify a nearby cell such as a Base Transceiver Station (BTS) and synchronize to the Time Division Multiple Access (TDMA) structures of the BTS. Each radio burst on the SCH may contain: the current frame clock of the serving BTS; the Base Station Identity Code (or BSIC), a truncated form of cell identity; and an extended Training Sequence that is easily detected with a matched filter. For further details regarding the burst structure of the SCH, please refer to the existing standards/specifications such as those of GSM.

According to some variations of this embodiment, the oscillator of the RTC 105 may stop oscillating during the power failure mentioned above. For example, the power failure may represent the power failure of a battery of the electronic device (e.g. a Li-ion/Li-polymer battery of the electronic device), where the RTC 105 does not have any valid power source during the power failure. In another example, the power failure may represent the power failure of a battery of the electronic device (e.g. a Li-ion/Li-polymer battery of the electronic device), where the RTC 105 is not equipped with any auxiliary power source which differs from the battery. Similar descriptions are not repeated in detail for these variations.

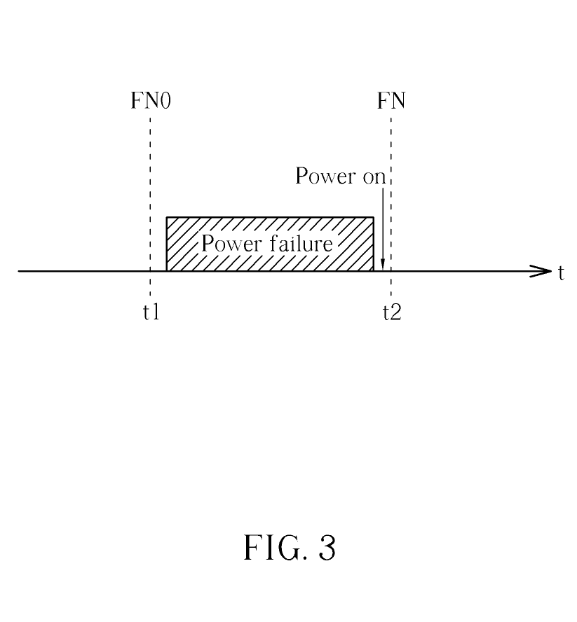

FIG. 3 illustrates a time recovery scheme involved with the method 200 shown in FIG. 2 according to an embodiment of the present invention, where the notation t labeled on the horizontal axis represents time, and the shaded portion labeled “Power failure” represents a period of the aforementioned power failure of the electronic device. Some exemplary frame numbers FN0 and FN are taken as examples of the frame number of the first frame and the frame number of the second frame, respectively. For example, the notations t1 and t2 may represent two time points respectively corresponding to the frame numbers FN0 and FN, and more particularly, a time point when (or just after) the first frame is received and a time point when (or just after) the second frame is received.

According to this embodiment, the second frame can be received from the same base station, and the first frame and the second frame belong to the same super-frame. The processing circuit 110 typically calculates a difference between the frame number FN of the second frame and the frame number FN0 of the first frame, such as the difference (FN−FN0), and calculates a remainder of division of the difference (FN−FN0) by a first predetermined factor PF1, such as the remainder mod((FN−FN0), PF1), with the function mod(x, y) representing the remainder of dividing x by y, where the first predetermined factor PF1 represents the number of frames within the super-frame. For example, within a super-frame based upon some communication standards, there are (2048*51*26) frames (which means PF1=2715648 in this situation), whose total length of time is approximately equivalent to 3.4813 hours when the duration per frame is defined as 4.615 ms. In addition, the processing circuit 110 typically calculates a product of the remainder mod((FN−FN0), PF1) and a second predetermined factor PF2, such as the product (mod((FN−FN0), PF1)*PF2), where the second predetermined factor PF2 represents the length of time of a frame, such as the aforementioned duration per frame (e.g., 4.615 ms, based upon some communication standards). Additionally, the processing circuit 110 typically calculates a sum of the original time value RTC0 and the product (mod((FN—FN0), PF1)*PF2), such as the sum (RTC0+(mod((FN−FN0), PF1)*PF2)), and utilizing the sum (RTC0+(mod((FN−FN0), PF1)*PF2)) as the calibrated time value RTC_FN. Thus, the calibrated time value RTC_FN can be expressed as follows:

RTC_{—}FN=RTC0+mod((FN−FN0), PF1)*PF2;

where the first predetermined factor PF1 and the second predetermined factor PF2 may vary, depending on different communication standards. Similar descriptions are not repeated in detail for this embodiment.

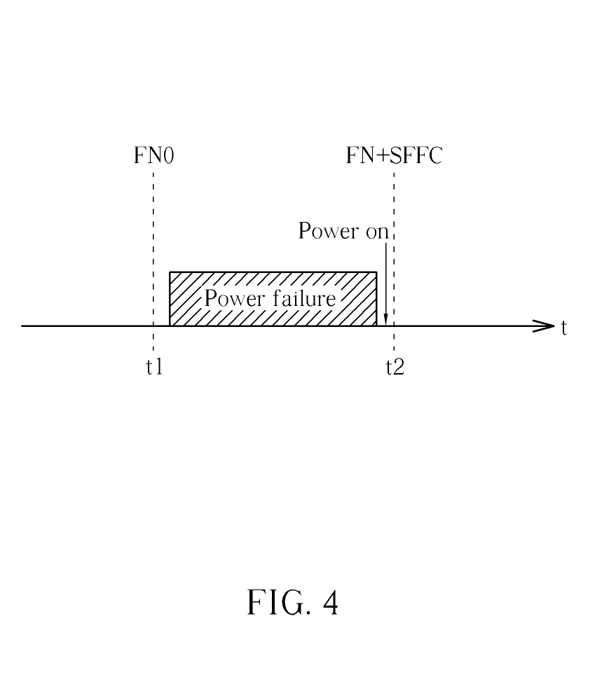

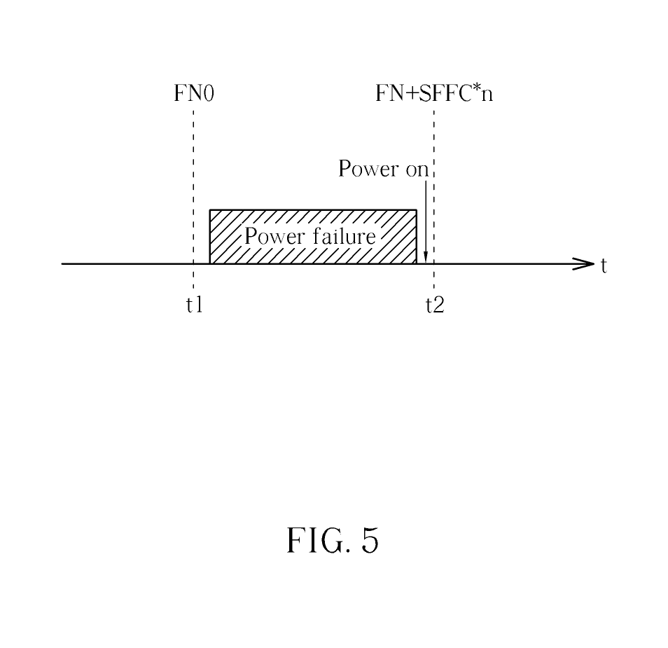

According to some variations of this embodiment, the frame number FN of the second frame can be replaced by a derivative of the frame number FN of the second frame. For example, referring to FIG. 4, the derivative of the frame number FN of the second frame can be equivalent to the frame number FN of the second frame plus the number of frames of a super-frame SFFC, such as (FN+SFFC), with the notation SFFC representing the super-frame frame count (i.e., the number of frames of a super-frame). In another example, referring to FIG. 5, the derivative of the frame number FN of the second frame can be equivalent to the frame number FN of the second frame plus a multiple of the number of frames of the super-frame SFFC, such as (FN+SFFC*n), with the notation n representing a positive integer (e.g. an integer that is greater than one). Thus, the calibrated time value RTC_FN can be expressed as follows:

RTC_{—}FN=RTC0+mod(((FN+SFFC)−FN0), PF1)*PF2; or

RTC_{—}FN=RTC0+mod(((FN+SFFC)*n−FN0), PF1)*PF2;

where the first predetermined factor PF1 and the second predetermined factor PF2 may vary, depending on different communication standards. Similar descriptions are not repeated in detail for these variations.

According to an embodiment, such as a variation of the embodiment shown in FIG. 3, the second frame can be received from the same base station, and the first frame and the second frame belong to the same super-frame. The processing circuit 110 typically calculates a difference between the frame number FN of the second frame and the frame number FN0 of the first frame, such as the difference (FN−FN0), and calculates a ratio of the difference (FN−FN0) to the first predetermined factor PF1, such as the ratio ((FN−FN0)/PF1). In addition, the processing circuit 110 typically calculates a product of the ratio ((FN−FN0)/PF1) and a third predetermined factor PF3, such as the product (((FN−FN0)/PF1)*PF3), where the third predetermined factor PF3 represents the length of time of a super-frame (which can be approximately 3.4813 hours, based upon some communication standards). Additionally, the processing circuit 110 typically calculates a sum of the original time value RTC0 and the product (((FN−FN0)/PF1)*PF3), such as the sum (RTC0+(((FN−FN0)/PF1)*PF3)), and utilizing the sum (RTC0+(((FN−FN0)/PF1)*PF3)) as the calibrated time value RTC_FN. Thus, the calibrated time value RTC_FN can be expressed as follows:

RTC_{—}FN=RTC0+((FN−FN0)/PF1)*PF3;

where the first predetermined factor PF1 and the third predetermined factor PF3 may vary, depending on different communication standards. Similar descriptions are not repeated in detail for this embodiment.

According to some variations of this embodiment, the frame number FN of the second frame can be replaced by a derivative of the frame number FN of the second frame. For example, referring to FIG. 4, the derivative of the frame number FN of the second frame can be equivalent to the frame number FN of the second frame plus the number of frames of a super-frame SFFC, such as (FN+SFFC). In another example, referring to FIG. 5, the derivative of the frame number FN of the second frame can be equivalent to the frame number FN of the second frame plus a multiple of the number of frames of the super-frame SFFC, such as (FN+SFFC*n). Thus, the calibrated time value RTC_FN can be expressed as follows:

RTC_{—}FN=RTC0+(((FN+SFFC)−FN0)/PF1)*PF3; or

RTC_{—}FN=RTC0+(((FN+SFFC)*n−FN0)/PF1)*PF3;

where the first predetermined factor PF1 and the third predetermined factor PF3 may vary, depending on different communication standards. Similar descriptions are not repeated in detail for these variations.

According to an embodiment, such as a variation of the embodiment shown in FIG. 3, the second frame can be received from another base station whose frames are respectively synchronized with those of the base station sending the first frame, where the first frame and the second frame respectively belong to super-frames that are synchronized with each other. The processing circuit 110 typically calculates a difference between the frame number FN of the second frame and the frame number FN0 of the first frame, such as the difference (FN−FN0), and calculates a remainder of division of the difference (FN−FN0) by the first predetermined factor PF1, such as the remainder mod((FN−FN0), PF1). In addition, the processing circuit 110 typically calculates a product of the remainder mod((FN−FN0), PF1) and the second predetermined factor PF2, such as the product (mod((FN−FN0), PF1)*PF2). Additionally, the processing circuit 110 typically calculates a sum of the original time value RTC0 and the product (mod((FN−FN0), PF1)*PF2), such as the sum (RTC0+(mod((FN−FN0), PF1)*PF2)), and utilizing the sum (RTC0+(mod((FN−FN0), PF1)*PF2)) as the calibrated time value RTC_FN. Thus, the calibrated time value RTC_FN can be expressed as follows:

RTC_{—}FN=RTC0+mod((FN−FN0), PF1)*PF2;

where the first predetermined factor PF1 and the second predetermined factor PF2 may vary, depending on different communication standards. Similar descriptions are not repeated in detail for this embodiment.

According to some variations of this embodiment, the frame number FN of the second frame can be replaced by a derivative of the frame number FN of the second frame. For example, referring to FIG. 4, the derivative of the frame number FN of the second frame can be equivalent to the frame number FN of the second frame plus the number of frames of a super-frame SFFC, such as (FN+SFFC). In another example, referring to FIG. 5, the derivative of the frame number FN of the second frame can be equivalent to the frame number FN of the second frame plus a multiple of the number of frames of the super-frame SFFC, such as (FN+SFFC*n). Thus, the calibrated time value RTC_FN can be expressed as follows:

RTC_{—}FN=RTC0+mod(((FN+SFFC)−FN0), PF1)*PF2; or

RTC_{—}FN=RTC0+mod(((FN+SFFC)*n−FN0), PF1)*PF2;

where the first predetermined factor PF1 and the second predetermined factor PF2 may vary, depending on different communication standards. Similar descriptions are not repeated in detail for these variations.

According to an embodiment, such as a variation of the embodiment shown in FIG. 3, the second frame can be received from another base station whose frames are respectively synchronized with those of the base station sending the first frame, where the first frame and the second frame respectively belong to super-frames that are synchronized with each other. The processing circuit 110 typically calculates a difference between the frame number FN of the second frame and the frame number FN0 of the first frame, such as the difference (FN−FN0), and calculates a ratio of the difference (FN−FN0) to the first predetermined factor PF1, such as the ratio ((FN−FN0)/PF1). In addition, the processing circuit 110 typically calculates a product of the ratio ((FN−FN0)/PF1) and the third predetermined factor PF3, such as the product (((FN−FN0)/PF1)*PF3). Additionally, the processing circuit 110 typically calculates a sum of the original time value RTC0 and the product (((FN−FN0)/PF1)*PF3), such as the sum (RTC0+(((FN−FN0)/PF1)*PF3)), and utilizing the sum (RTC0+(((FN−FN0)/PF1)*PF3)) as the calibrated time value RTC_FN. Thus, the calibrated time value RTC_FN can be expressed as follows:

RTC_{—}FN=RTC0+mod((FN−FN0), PF1)*PF3;

where the first predetermined factor PF1 and the third predetermined factor PF3 may vary, depending on different communication standards. Similar descriptions are not repeated in detail for this embodiment.

According to some variations of this embodiment, the frame number FN of the second frame can be replaced by a derivative of the frame number FN of the second frame. For example, referring to FIG. 4, the derivative of the frame number FN of the second frame can be equivalent to the frame number FN of the second frame plus the number of frames of a super-frame SFFC, such as (FN+SFFC). In another example, referring to FIG. 5, the derivative of the frame number FN of the second frame can be equivalent to the frame number FN of the second frame plus a multiple of the number of frames of the super-frame SFFC, such as (FN+SFFC*n). Thus, the calibrated time value RTC_FN can be expressed as follows:

RTC_{—}FN=RTC0+(((FN+SFFC)−FN0)/PF1)*PF3; or

RTC_{—}FN=RTC0+(((FN+SFFC)*n−FN0)/PF1)*PF3;

where the first predetermined factor PF1 and the third predetermined factor PF3 may vary, depending on different communication standards. Similar descriptions are not repeated in detail for these variations.

It is an advantage of the present invention that the present invention method and apparatus can reconfigure the RTC of the electronic device with ease to recover the time accuracy. In addition, in a situation where the RTC of the electronic device stops working during power failure of the electronic device (e.g. the RTC does not have any valid power source such as a workable capacitor or a workable button-shaped or coin-shaped battery during replacement of the aforementioned Li-ion/Li-polymer battery of the electronic device, or the aforementioned oscillator of the RTC stops oscillating due to replacement or deficiency of a supplementary power source of the RTC), the present invention method and apparatus can recover the time accuracy. Additionally, as the present invention method and apparatus can recover the time accuracy with ease, a supplementary power source such as a capacitor or a button-shaped or coin-shaped battery is not required for the RTC of the electronic device, and therefore, the associated costs can be significantly reduced and the end user can buy the product at a budget price.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for performing real time clock (RTC) calibration through frame number calculation, the method being applied to an electronic device, the method comprising the steps of:
before power failure of the electronic device occurs, obtaining an original time value from an RTC of the electronic device and storing the original time value and a frame number of a first frame into a storage unit, wherein the first frame is received from a base station; and
after the electronic device is powered on since elimination of the power failure, obtaining a frame number of a second frame and performing at least one calculation operation according to the frame number of the second frame, the frame number of the first frame, and the original time value to determine a calibrated time value of the RTC, and updating the RTC with at least one of the calibrated time value and a derivative of the calibrated time value.

2. The method of claim 1, wherein obtaining the original time value from the RTC of the electronic device further comprises:
obtaining the original time value from the RTC after the first frame is received from the base station.

3. The method of claim 2, wherein obtaining the original time value from the RTC of the electronic device further comprises:
obtaining the original time value from the RTC before a frame next to the first frame is received from the base station.

4. The method of claim 1, wherein an oscillator of the RTC stops oscillating during the power failure.

5. The method of claim 4, wherein the power failure represents power failure of a battery of the electronic device; and the RTC does not have any valid power source during the power failure.

6. The method of claim 4, wherein the power failure represents power failure of a battery of the electronic device; and the RTC is not equipped with any auxiliary power source which differs from the battery.

7. The method of claim 1, wherein the second frame is received from the base station; the first frame and the second frame belong to a same super-frame; and performing the at least one calculation operation according to the frame number of the second frame, the frame number of the first frame, and the original time value to determine the calibrated time value of the RTC further comprises:
calculating a difference between the frame number of the second frame and the frame number of the first frame;
calculating a remainder of division of the difference by a first predetermined factor, where the first predetermined factor represents a number of frames within the super-frame;
calculating a product of the remainder and a second predetermined factor, where the second predetermined factor represents a length of time of a frame; and
calculating a sum of the original time value and the product and utilizing the sum as the calibrated time value.

8. The method of claim 1, wherein the second frame is received from the base station; the first frame and the second frame belong to a same super-frame; and performing the at least one calculation operation according to the frame number of the second frame, the frame number of the first frame, and the original time value to determine the calibrated time value of the RTC further comprises:
calculating a difference between the frame number of the second frame and the frame number of the first frame;
calculating a ratio of the difference to a first predetermined factor, where the first predetermined factor represents a number of frames within the super-frame;
calculating a product of the ratio and a third predetermined factor, where the third predetermined factor represents a length of time of a super-frame; and
calculating a sum of the original time value and the product and utilizing the sum as the calibrated time value.

9. The method of claim 1, wherein the second frame is received from the base station; the first frame and the second frame belong to different super-frames; and performing the at least one calculation operation according to the frame number of the second frame, the frame number of the first frame, and the original time value to determine the calibrated time value of the RTC further comprises:
calculating a difference between a derivative of the frame number of the second frame and the frame number of the first frame;
calculating a remainder of division of the difference by a first predetermined factor, where the first predetermined factor represents a number of frames within the super-frame;
calculating a product of the remainder and a second predetermined factor, where the second predetermined factor represents a length of time of a frame; and
calculating a sum of the original time value and the product and utilizing the sum as the calibrated time value;
wherein the derivative of the frame number of the second frame is equivalent to the frame number of the second frame plus a number of frames of a super-frame, or is equivalent to the frame number of the second frame plus a multiple of the number of frames of the super-frame.

10. The method of claim 1, wherein the second frame is received from the base station; the first frame and the second frame belong to different super-frames; and performing the at least one calculation operation according to the frame number of the second frame, the frame number of the first frame, and the original time value to determine the calibrated time value of the RTC further comprises:
calculating a difference between a derivative of the frame number of the second frame and the frame number of the first frame;
calculating a ratio of the difference to a first predetermined factor, where the first predetermined factor represents a number of frames within the super-frame;
calculating a product of the ratio and a third predetermined factor, where the third predetermined factor represents a length of time of a super-frame; and
calculating a sum of the original time value and the product and utilizing the sum as the calibrated time value;
wherein the derivative of the frame number of the second frame is equivalent to the frame number of the second frame plus a number of frames of a super-frame, or is equivalent to the frame number of the second frame plus a multiple of the number of frames of the super-frame.

11. The method of claim 1, wherein the second frame is received from another base station whose frames are respectively synchronized with those of the base station sending the first frame; the first frame and the second frame respectively belong to super-frames that are synchronized with each other; and performing the at least one calculation operation according to the frame number of the second frame, the frame number of the first frame, and the original time value to determine the calibrated time value of the RTC further comprises:
calculating a difference between the frame number of the second frame and the frame number of the first frame;
calculating a remainder of division of the difference by a first predetermined factor, where the first predetermined factor represents a number of frames within the super-frame;
calculating a product of the remainder and a second predetermined factor, where the second predetermined factor represents a length of time of a frame; and
calculating a sum of the original time value and the product and utilizing the sum as the calibrated time value.

12. The method of claim 1, wherein the second frame is received from another base station whose frames are respectively synchronized with those of the base station sending the first frame; the first frame and the second frame respectively belong to super-frames that are synchronized with each other; and performing the at least one calculation operation according to the frame number of the second frame, the frame number of the first frame, and the original time value to determine the calibrated time value of the RTC further comprises:
calculating a difference between the frame number of the second frame and the frame number of the first frame;
calculating a ratio of the difference to a first predetermined factor, where the first predetermined factor represents a number of frames within the super-frame;
calculating a product of the ratio and a third predetermined factor, where the third predetermined factor represents a length of time of a super-frame; and
calculating a sum of the original time value and the product and utilizing the sum as the calibrated time value.

13. The method of claim 1, wherein the second frame is received from another base station whose frames are respectively synchronized with those of the base station sending the first frame; the first frame and the second frame respectively belong to super-frames that are not synchronized with each other; and performing the at least one calculation operation according to the frame number of the second frame, the frame number of the first frame, and the original time value to determine the calibrated time value of the RTC further comprises:
calculating a difference between a derivative of the frame number of the second frame and the frame number of the first frame;
calculating a remainder of division of the difference by a first predetermined factor, where the first predetermined factor represents a number of frames within the super-frame;
calculating a product of the remainder and a second predetermined factor, where the second predetermined factor represents a length of time of a frame; and
calculating a sum of the original time value and the product and utilizing the sum as the calibrated time value;
wherein the derivative of the frame number of the second frame is equivalent to the frame number of the second frame plus a number of frames of a super-frame, or is equivalent to the frame number of the second frame plus a multiple of the number of frames of the super-frame.

14. The method of claim 1, wherein the second frame is received from another base station whose frames are respectively synchronized with those of the base station sending the first frame; the first frame and the second frame respectively belong to super-frames that are not synchronized with each other; and performing the at least one calculation operation according to the frame number of the second frame, the frame number of the first frame, and the original time value to determine the calibrated time value of the RTC further comprises:
calculating a difference between a derivative of the frame number of the second frame and the frame number of the first frame;
calculating a ratio of the difference to a first predetermined factor, where the first predetermined factor represents a number of frames within the super-frame;
calculating a product of the ratio and a third predetermined factor, where the third predetermined factor represents a length of time of a super-frame; and
calculating a sum of the original time value and the product and utilizing the sum as the calibrated time value;
wherein the derivative of the frame number of the second frame is equivalent to the frame number of the second frame plus a number of frames of a super-frame, or is equivalent to the frame number of the second frame plus a multiple of the number of frames of the super-frame.

15. The method of claim 1, further comprising:
providing a user with a user interface, allowing the user to select a derivative of the frame number of the second frame, for use of performing the at least one calculation operation;
wherein the derivative of the frame number of the second frame is equivalent to the frame number of the second frame plus a number of frames of a super-frame, or is equivalent to the frame number of the second frame plus a multiple of the number of frames of the super-frame.

16. The method of claim 1, wherein the power failure represents power failure of a battery of the electronic device; and the method further comprises:
when it is detected that replacing or charging the battery is required, triggering the step of obtaining the original time value from the RTC of the electronic device and storing the original time value and the frame number of the first frame into the storage unit.

17. The method of claim 16, further comprising:
detecting whether an output voltage level of the battery is less than a predetermined threshold to determine whether replacing or charging the battery is required.

18. An apparatus for performing real time clock (RTC) calibration through frame number calculation, the apparatus comprising at least one portion of an electronic device, the apparatus comprising:
a storage unit arranged to temporarily store information; and
a processing circuit arranged to control operations of the electronic device, wherein before power failure of the electronic device occurs, the processing circuit obtains an original time value from an RTC of the electronic device and stores the original time value and a frame number of a first frame into the storage unit, wherein the first frame is received from a base station;
wherein after the electronic device is powered on since elimination of the power failure, the processing circuit obtains a frame number of a second frame and performs at least one calculation operation according to the frame number of the second frame, the frame number of the first frame, and the original time value to determine a calibrated time value of the RTC, and updates the RTC with at least one of the calibrated time value and a derivative of the calibrated time value.

19. The apparatus of claim 18, wherein the processing circuit obtains the original time value from the RTC after the first frame is received from the base station.

20. The apparatus of claim 18, wherein an oscillator of the RTC stops oscillating during the power failure.
